(19) United States
(12) Patent Application Publication
(10) Pub. No.: US 2020/0150472 A1
(43) Pub. Date: May 14, 2020

(54) SUBSTRATE FOR DISPLAY DEVICE, DISPLAY DEVICE, AND METHOD OF PRODUCING SUBSTRATE FOR DISPLAY DEVICE

(71) Applicant: Sharp Kabushiki Kaisha, Sakai City (JP)

(72) Inventors: Tetsuo KIKUCHI, Sakai City (JP); Tohru DAITOH, Sakai City (JP); Hajime IMAI, Sakai City (JP); Masahiko SUZUKI, Sakai City (JP); Setsuji NISHIMIYA, Sakai City (JP); Teruyuki UEDA, Sakai City (JP); Kengo HARA, Sakai City (JP); Masamitsu YAMANAKA, Sakai City (JP); Hitoshi TAKAHATA, Sakai City (JP)

(21) Appl. No.: 16/683,726

(22) Filed: Nov. 14, 2019

Related U.S. Application Data
(60) Provisional application No. 62/767,068, filed on Nov. 14, 2018.

(51) Int. Cl. G02F 1/1368; G02F 1/1362; G02F 1/1333

(52) U.S. Cl. CPC G02F 1/1368; G02F 1/136286; G09G 3/3648; G02F 1/133345; G02F 1/136209

(57) ABSTRACT

A substrate includes thin film transistors, each of which includes: an upper gate electrode formed of a first conductive film and continuous with one of gate lines; a source electrode formed of a second conductive film and continuous with one of source lines; a channel region formed of a portion of a semiconductor film over which an upper gate insulating film is disposed and overlapping the upper gate electrode; a source region formed of a portion of the semiconductor film and continuous with the channel region, and a drain region formed of a portion of the semiconductor film and continuous with the channel region on an opposite side of the channel region from the source region. The source electrode connects the source line and the source region through a first contact hole in an interlayer insulating film disposed over the first conductive film and containing a photosensitive material.

### CROSS REFERENCE TO RELATED APPLICATION

This application claims priority from U.S. Provisional Patent Application No. 62/767,068 filed on Nov. 14, 2018. The entire contents of the priority application are incorporated herein by reference.

### TECHNICAL FIELD

The technology described herein relates to a substrate for a display device, a display device, and a method of producing a substrate for a display device.

### BACKGROUND

A liquid crystal display device includes a liquid crystal panel as a main component in which multiple pixels are arranged in a matrix. The alignment of the molecules in each pixel is controlled by adjusting a voltage applied to the pixel such that the liquid crystal display device displays an intended image. The voltage applied to each pixel is adjusted by the switching device provided for each pixel. Thin film transistors (TFTs) are widely used as the switching devices. The switching properties of the TFTs are controlled by using the gate electrode and a driving signal applied between the source electrode and the drain electrode.

The TFTs are included in one of the substrates (array substrate) constituting the liquid crystal panel and have a multi-layer structure including thin films. One example of the multi-layer structure is described in Japanese Unexamined Patent Application Publication No. 2016-219801 listed below. The TFT described in the patent document includes a semiconductor film formed of an oxide semiconductor and a gate electrode disposed over the middle portion (channel region) of the semiconductor film with a gate insulating film therebetween. This structure in which the gate electrode is disposed above the semiconductor film is called a top gate structure. The TFT having a top gate structure is relatively readily produced at a lower cost.

Furthermore, as described in the patent document, the source electrode is disposed over one of the end portions (source region) of the semiconductor film. The source electrode is connected to the source region of the underlying semiconductor film through the contact hole connecting the layers. In the same way, the drain electrode is disposed over the other end portion (drain region) of the semiconductor film. The drain electrode is connected to the drain region of the underlying semiconductor film through the contact hole. For example, the contact holes in the patent document are deep holes having a depth of 400 nm. The depth larger than a predetermined depth reduces parasitic capacitance between the source line connected to the source electrode and the gate line connected to the gate electrode and provides pressure resistance.

The contact holes described in the patent document are formed by etching. The formation of a deep hole having a depth of 400 nm involves a long etching time. The resist pattern used as a mask is more etched as the etching time increases. This makes the openings in the resist pattern wider and increases the opening diameter of the resist pattern. The diameter of the contact hole formed by using the resist pattern having the increased opening diameter is larger than the original opening diameter of the resist pattern formed using photolithography, for example. In a liquid crystal panel, the contact holes are present in the light-blocking portion of the display area or the peripheral portion of the non-display area. These portions need to be made larger in advance to have the contact holes having large diameters. This leads to a decrease in the aperture ratio of the display area and an increase in the area of the peripheral portion (frame).

### SUMMARY

The technology described herein was made in view of the above-described circumstance. It is an object thereof to provide a substrate for a display device having a contact hole having a small diameter. It is another object to provide a display device having an increased aperture ratio and a narrower frame by including the substrate for a display device.

An embodiment of the technology described herein is a substrate for a display device including thin film transistors. The substrate for a display device includes a semiconductor film, an upper gate insulating film disposed over the semiconductor film, a first conductive film disposed over the upper gate insulating film, an interlayer insulating film disposed over the first conductive film, and a second conductive film disposed over the first conductive film with the interlayer insulating film therebetween. Gate lines formed of the first conductive film and source lines formed of the second conductive film intersect in a grid pattern to surround the thin film transistors. The thin film transistors each include an upper gate electrode formed of the first conductive film and continuous with one of the gate lines, a source electrode formed of the second conductive film and continuous with one of the source lines, a channel region formed of a portion of the semiconductor film and overlapping the upper gate electrode, a source region formed of a portion of the semiconductor film and continuous with the channel region, and a drain region formed of a portion of the semiconductor film and continuous with the channel region on an opposite side of the channel region from the source region. The source electrode connects the source line and the source region to each other through a first contact hole extending through the interlayer insulating film. The interlayer insulating film contains a photosensitive material.

Furthermore, an embodiment of the invention is a display device including the substrate for a display device according to the above-described configuration and a counter substrate facing the substrate for a display device with a space therebetween.

Furthermore, an embodiment of the invention is a method of producing a substrate for a display device. The substrate includes a semiconductor film, an upper gate insulating film disposed over the semiconductor film, a first conductive film disposed over the upper gate insulating film, a first interlayer insulating film disposed over the first conductive film and not having photosensitivity, and a second interlayer insulating film disposed over the first interlayer insulating film and having photosensitivity. The method includes a first interlayer insulating film formation step of forming the first interlayer insulating film over the first conductive film, a second interlayer insulating film formation step of forming the second interlayer insulating film over the first interlayer insulating film, a second interlayer insulating film patterning step of patterning the second interlayer insulating film after the second interlayer insulating film formation step, and a first interlayer insulating film etching step of etching the first interlayer insulating film using the patterned second interlayer insulating film as a mask to selectively remove a portion of the first interlayer insulating film and pattern the first interlayer insulating film after the second interlayer insulating film patterning step.

The technology described herein provides a substrate for a display device having a contact hole having a smaller diameter. Furthermore, the technology described herein provides a display device having a higher aperture ratio and a narrower frame by including the substrate for a display device.

### BRIEF DESCRIPTION OF THE DRAWINGS

FIG. 1 is a plan view illustrating a liquid crystal display device according to a first embodiment of the invention.

FIG. 2 is a cross-sectional view taken along line II-II in FIG. 1 and illustrating a cross-sectional configuration of an entire liquid crystal panel.

FIG. 3 is a plan view illustrating a wiring structure of an array substrate included in the liquid crystal panel.

FIG. 4 is a magnified plan view illustrating a portion of the display area of the array substrate.

FIG. 5 is a cross-sectional view taken along line V-V in FIG. 4.

FIG. 6 is a magnified cross-sectional view illustrating a portion of the non-display area of the array substrate.

FIG. 7 is a magnified cross-sectional view illustrating another portion of the non-display area of the array substrate.

FIG. 8 is a flow chart of a production process of the array substrate.

FIG. 9 is a flow chart of a production process of the array substrate.

FIG. 10A is a view illustrating a step of forming a first contact hole and a second contact hole.

FIG. 10B is a view illustrating a step of forming the first contact hole and the second contact hole.

FIG. 10C is a view illustrating a step of forming the first contact hole and the second contact hole.

FIG. 10D is a view illustrating a step of forming the first contact hole and the second contact hole.

FIG. 11A is a view illustrating a step of forming a fourth contact hole.

FIG. 11B is a view illustrating a step of forming the fourth contact hole.

FIG. 11C is a view illustrating a step of forming the fourth contact hole.

FIG. 11D is a view illustrating a step of forming the fourth contact hole.

FIG. 12A is a view illustrating a step of forming a fifth contact hole.

FIG. 12B is a view illustrating a step of forming the fifth contact hole.

FIG. 12C is a view illustrating a step of forming the fifth contact hole.

FIG. 12D is a view illustrating a step of forming the fifth contact hole.

FIG. 13A is a view illustrating a step of forming a fourth contact hole in an array substrate according to a first modification.

FIG. 13B is a view illustrating a step of forming the fourth contact hole in the array substrate according to the first modification.

FIG. 13C is a view illustrating a step of forming the fourth contact hole in the array substrate according to the first modification.

FIG. 13D is a view illustrating a step of forming the fourth contact hole in the array substrate according to the first modification.

FIG. 14A is a view illustrating a step of forming a fifth contact hole in an array substrate according to the first modification.

FIG. 14B is a view illustrating a step of forming the fifth contact hole in the array substrate according to the first modification.

FIG. 14C is a view illustrating a step of forming the fifth contact hole in the array substrate according to the first modification.

FIG. 14D is a view illustrating a step of forming the fifth contact hole in the array substrate according to the first modification.

FIG. 15A is a view illustrating a step of forming a fifth contact hole in an array substrate according to a second modification.

FIG. 15B is a view illustrating a step of forming the fifth contact hole in the array substrate according to the second modification.

FIG. 15C is a view illustrating a step of forming the fifth contact hole in the array substrate according to the second modification.

FIG. 15D is a view illustrating a step of forming the fifth contact hole in the array substrate according to the second modification.

### DETAILED DESCRIPTION

### First Embodiment

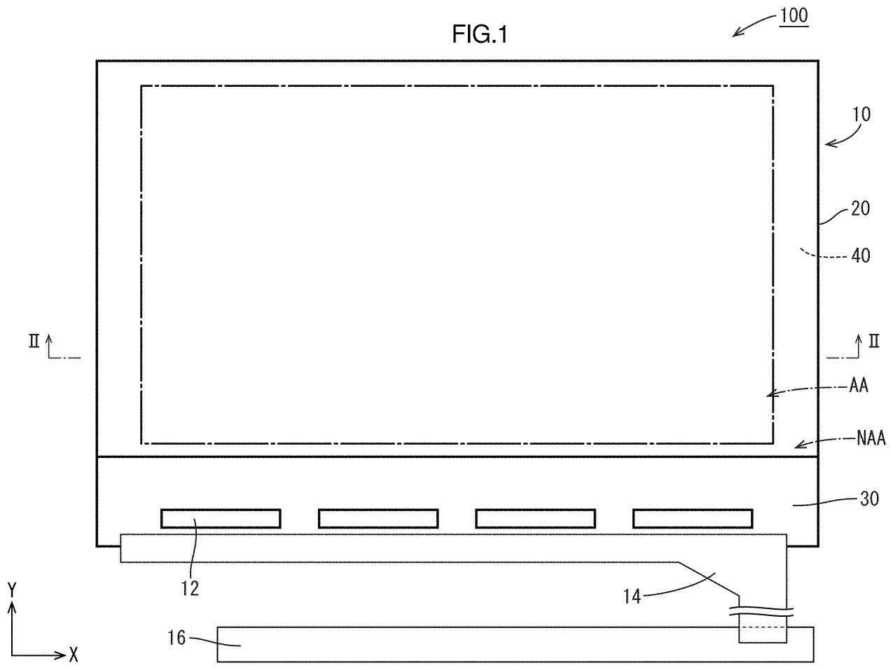

A first embodiment of the invention is described with reference to FIG. 1 to FIG. 12D. In this embodiment, a liquid crystal display device 100 (one example of a display device) including a liquid crystal panel 10 (display panel) is described as an example. The X axis, the Y axis, and the Z axis are indicated in some of FIGS. 1 to 3, and each of the axes indicates the same direction in the respective drawings. Furthermore, in the cross-sectional views, the upper side and the lower side, respectively, correspond to the front side and the rear side of the liquid crystal panel 10.

As illustrated in a plan view in FIG. 1, the liquid crystal display device 100 includes at least a liquid crystal panel 10 configured to display an image, drivers 12 configured to drive the liquid crystal panel 10, a control board (source board) 16 serving as a signal source that supplies various input signals from an external device to the drivers 12, a flexible board 14 serving as a signal transmitter electrically connecting the liquid crystal panel 10 and the drivers 12 to the control board 16, and a backlight device serving as an external light source located on the rear side of the liquid crystal panel 10 and configured to apply display light to the liquid crystal panel 10.

As illustrated in FIG. 1, the liquid crystal panel 10 has a horizontally long rectangular (oblong) overall shape. The middle portion of the surface of the liquid crystal panel 10 is a display area (active area) capable of displaying an image and the peripheral portion thereof surrounding the display area AA is a non-display area (non-active area) NAA. The non-display area NAA has a frame-like (picture-frame-like) shape in plan view. The long-side direction of the liquid crystal panel 10 matches the X axis direction in the drawings, the short-side direction thereof matches the Y axis direction in the drawings, and the thickness direction matches the Z axis direction. In FIG. 1, a one-dot chain line indicates an outline of the display area AA and the area outside the one-dot chain line is the non-display area NAA.

In this embodiment, four drivers 12 are disposed in the non-display area NAA of the liquid crystal panel 10 along one of the long sides (ends extending in the X axis direction) with a space therebetween in the X axis direction. The driver 12 includes an LSI chip having an internal driving circuit and processes various signals sent from the flexible board 14. The flexible board 14 is connected to the non-display area NAA of the liquid crystal panel 10 at one end and connected to the control board 16 at the other end. The flexible board 14 transmits various signals from the control board 16 to the liquid crystal panel 10. The signal from the control board 16 is processed by the driver 12 and then outputted to a source line 43, a gate line 44, and a gate driving circuit 45, which will be described later.

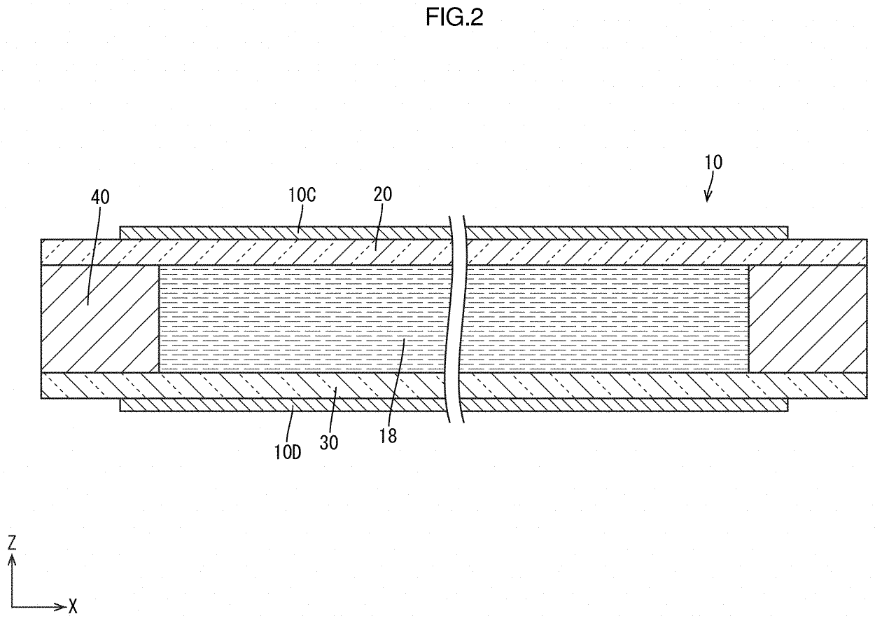

As illustrated in a cross-sectional view in FIG. 2, the liquid crystal panel 10 includes at least two substrates 20 and 30, a liquid crystal layer 18 sandwiched between the substrates 20 and 30 and containing liquid crystal molecules, which are substances whose optical properties are changed by application of an electric field, and a sealing member 40 disposed between the substrates 20 and 30 and surrounding the liquid crystal layer 18 to seal the liquid crystal layer 18 with a cell gap corresponding to the thickness of the liquid crystal layer 18 therebetween. One of the substrates 20 and 30 on the front side (front surface side) is a CF substrate (counter substrate, color filter substrate) 20, and the other on the rear side (rear surface side) is an array substrate (substrate for a display device, active matrix substrate, TFT substrate) 30. The CF substrate 20 and the array substrate 30 each include a glass substrate and various films on the inner surface of the glass substrate. The sealing member 40 is located in the non-display area NAA of the liquid crystal panel 10 and has a horizontally long frame-like shape in plan view as the non-display area NAA. The substrates 20 and 30 have polarizing plates 10C and 10D on the outer surfaces.

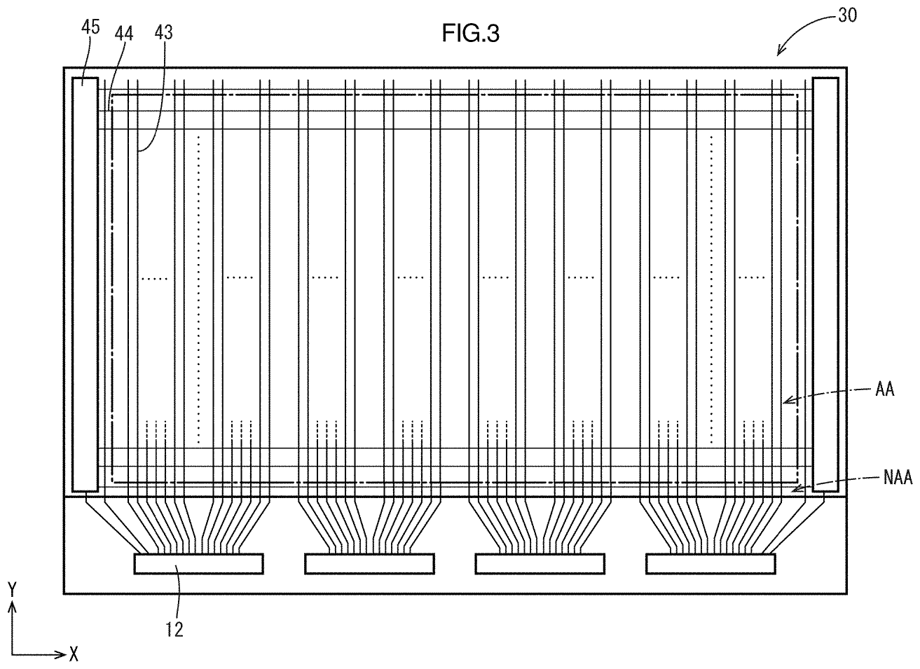

As illustrated in a plan view in FIG. 3, the array substrate 30 includes multiple source lines (date lines, signal lines) 43 and multiple gate lines (scanning lines) 44 intersecting each other in a grid pattern. The source lines 43 are connected to source driving circuits in the drivers 12 and signals from the source driving circuits are sent to the source lines 43. The gate lines 44 are connected to gate driving circuits 45 of the array substrate 30, which are located at the short-side portions (ends extending in the Y axis direction) of the non-display area NAA. Scanning signals are sent from the gate driving circuits 45 to the gate lines 44.

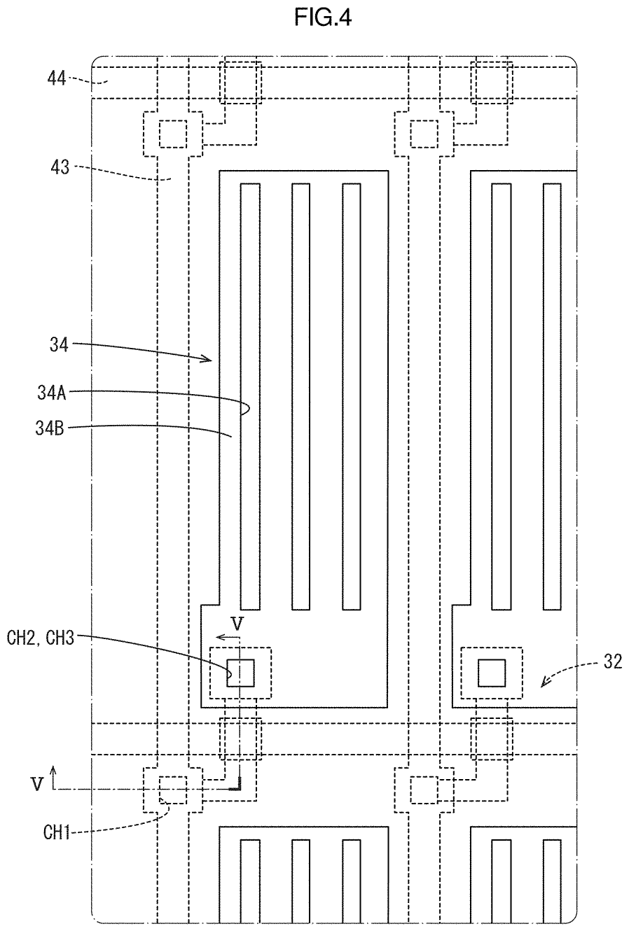

As illustrated in a magnified plan view in FIG. 4, one TFT 32, which is a switching device, is disposed around each of intersections between the source lines 43 and the gate lines 44 in the display area AA. In other words, the TFTs 32 are each surrounded by the source lines 43 and the gate lines 44. Furthermore, a pixel electrode 34 having three slits 34A is disposed in each of areas defined by the source lines 43 and the gate lines 44. The pixel electrode 34 is connected to the TFT 32 at one end through contact holes CH2 and CH3. Image signals from the gate driving circuits 45 and the source driving circuits in the drivers 12 are sent to the TFTs 32 through the source lines 43 and the gate lines 44 and change the potentials of the pixel electrodes 34 connected to the TFTs 32. The electric field applied to the liquid crystal layer 18 is controlled by adjusting the potential of the pixel electrode such that the alignment states of the liquid crystal molecules are properly switched to drive the liquid crystal panel 10.

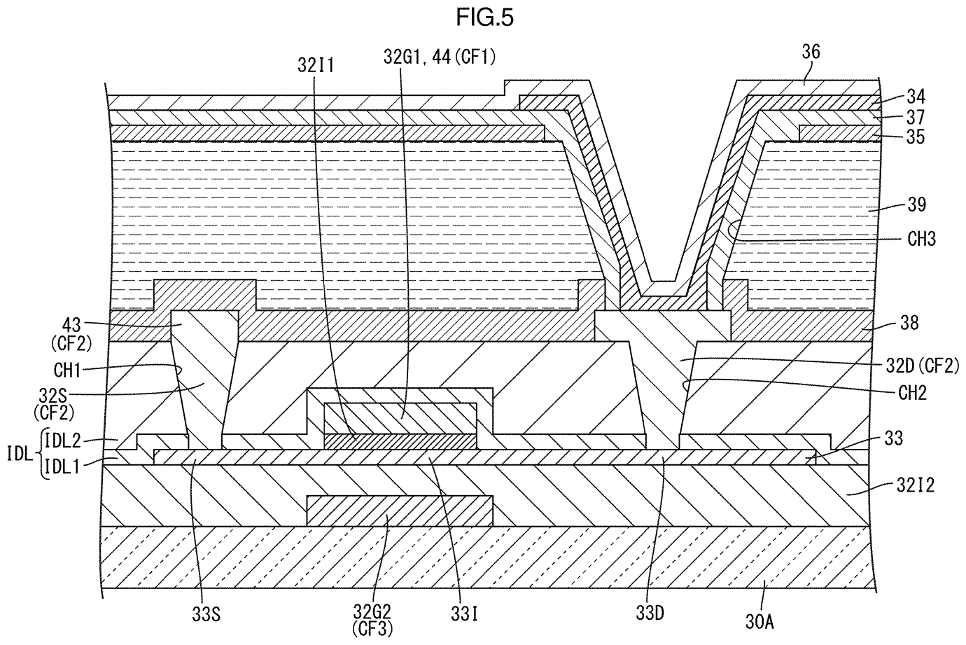

As illustrated in FIG. 4, the pixel electrode 34 has at least one slit 34A (three slits in this embodiment), which is a thin opening. The slit 34A shapes the pixel electrode 34 into a ladder-like planar shape having multiple parallel linear portions 34B (four linear portions in this embodiment) spaced apart from each other. As illustrated in FIG. 5 (a cross-sectional view taken along line V-V in FIG. 4), a common electrode 35 is disposed in a solid pattern under the pixel electrodes 34. The pixel electrodes 34 and the common electrode 35 are formed of a transparent conductive material, such as indium tin oxide (ITO).

As illustrated in FIG. 5, a first insulating film 37 is disposed between the pixel electrodes 34 and the common electrode 35. The first insulating film 37 is formed of an inorganic insulating material, such as silicon nitride (SiNₓ) and silicon dioxide (SiO₂). An alignment film 36 formed of an organic insulating material (for example, a polyimide resin) is disposed over those films to cover the laminated layers of the common electrode 35, the first insulating film 37, and the pixel electrodes 34. The alignment film 36 is the innermost layer of the array substrate 30 (adjacent to the liquid crystal layer 18) and is in contact with the liquid crystal layer 18 to align the liquid crystal molecules contained in the liquid crystal layer 18.

A reference potential is applied to the common electrode 35 through a common electrode line. A potential applied to the pixel electrode 34 is controlled by the TFT 32 such that a predetermined voltage is applied between the pixel electrode 34 and the common electrode 35 to generate an electric field applied to the liquid crystal layer 18. Due to the electric field between the linear portion 34B of the pixel electrode 34 and the common electrode 35, a fringe electric field (oblique electric field) containing a component normal to the plate surface of the array substrate 30 is generated in the liquid crystal layer 18 in addition to a component parallel to the plate surface of the array substrate 30. This enables switching of the alignment states of the liquid crystal molecules contained in the liquid crystal layer 18. In other words, the liquid crystal panel 10 of the embodiment operates in a fringe field switching (FFS) mode. The FFS mode liquid crystal panel has a high aperture ratio, which allows a sufficient amount of light to pass, and has high viewing angle properties.

Next, the TFT 32 is described in detail. As illustrated in FIG. 5, the TFT 32 includes a semiconductor film 33, an upper gate insulating film 3211 disposed over the semiconductor film 33, and an upper gate electrode 32G1 disposed over the upper gate insulating film 3211. The semiconductor film 33 is formed of an oxide semiconductor, such as indium gallium zinc oxide (IGZO). The upper gate insulating film 3211 is a single layer film or a multi-layer film formed of at least one of transparent inorganic materials, such as silicon oxide (SiOx), silicon oxynitride (SiON), and silicon nitride (SiNx), and insulates between the upper gate electrode 32G1 and the semiconductor film 33. The semiconductor film 33 includes a channel region 331 overlapping the upper gate electrode 32G1, a source region 33S continuous with the channel region, and a drain region 33D continuous with the channel region 331 on the opposite side of the channel region 331 from the source region 33S.

As illustrated in FIG. 5, a two-layer interlayer insulating film IDL including a first interlayer insulating film IDL1 and a second interlayer insulating film IDL2 is disposed over the upper gate electrode 32G1. The first interlayer insulating film IDL1 is formed of a non-photosensitive insulating material, such as an inorganic insulating material, including silicon nitride (SiNₓ) and silicon dioxide (SiO₂). The second interlayer insulating film IDL2 is formed of a photosensitive insulating material, such as a transparent organic insulating material, including an acrylic resin (for example, PMMA) and a polyimide resin, and an inorganic polymer material, including SiO₂ produced by using spin on glass (SOG). The second interlayer insulating film IDL2 has a larger thickness than the first interlayer insulating film IDL1. In this embodiment, the first interlayer insulating film IDL1 has a thickness of 100 nm and the second interlayer insulating film IDL2 has a thickness of 400 nm. The overall thickness of the interlayer insulating film IDL is 500 nm.

A source line 43 extending in the Y axis direction is disposed over the second interlayer insulating film IDL2. As illustrated in FIGS. 4 and 5, the interlayer insulating film IDL including the second interlayer insulating film IDL2 has a first contact hole CH1 extending through the interlayer insulating film IDL in the thickness direction (Z axis direction) at a position where the source line 43 overlaps the source region 33S of the semiconductor film 33. The TFT 32 includes a source electrode 32S extending along the first contact hole CH1. The source electrode 32S is continuous with the source line 43 and connects the source line 43 and the source region 33S to each other through the first contact hole CH1. Furthermore, the interlayer insulating film IDL has a second contact hole CH2 extending therethrough in the thickness direction (Z axis direction) and connecting the drain region 33D of the semiconductor film 33 and the pixel electrode 34 to each other. The TFT 32 includes a drain electrode 32D extending along the second contact hole CH2. The drain electrode 32D is in contact with the pixel electrode 34 and connects the pixel electrode 34 and the drain region 33D to each other through the second contact hole CH2.

The gate line 44 and the upper gate electrode 32G1 are formed of the same material(s) and are formed of a single-layer conductive film or a multi-layer conductive film formed of at least one of tungsten (W), copper (Cu), Cu alloy, molybdenum (Mo), Mo alloy, titanium (Ti), aluminum (Al), Al alloy, ITO, and indium zinc oxide (IZO). The source line 43, the source electrode 32S, and the drain electrode 32D are formed of the same material(s) and are formed of a single-layer conductive film or a multi-layer conductive film formed of at least one of W, Cu, Cu alloy, Mo, Mo alloy, Ti, Al, Al alloy, ITO, and IZO.

The drain electrode 32D and the source electrode 32S are indirectly electrically connected to each other through the drain region 33D and the source region 33S of the underlying semiconductor film 33. When an image signal is supplied through the source line 43, a drain current flows between the drain region 33D and the source region 33S through the channel region 331. The upper gate electrode 32G1 is continuous with the gate line 44. The drain current flowing between the drain region 33D and the source region 33S is switched between an on state and an off state in accordance with a scanning signal sent from the gate line 44 to the upper gate electrode 32G1. The potential of the pixel electrode 34 connected to the drain electrode 32D is changed by the switching of the drain current.

The TFT 32 has a top gate structure in which a gate electrode (upper gate electrode 32G1) is located above the semiconductor film 33. In the TFT 32 having a top gate structure, the interlayer insulating film IDL needs to have a certain level of thickness to reduce parasitic capacitance between the source line 43 connected to the source electrode 32S and the gate line 44 connected to the upper gate electrode 32G1 and to have enough pressure resistance to avoid breakdown. However, if the thickness of the interlayer insulating film IDL is too large, the formation of the film takes a longer time, leading to a decrease in the production capacity of the film-forming apparatus, and the etching of the interlayer insulating film IDL for the contact hole takes a longer time, leading to a decrease in the production capacity of an etching apparatus. In addition, the substrate may be warped due to the film stress. Thus, the thickness of the interlayer insulating film IDL is preferably in a range of about 300 nm to about 700 nm, and more preferably in a range of about 400 nm to about 500 nm.

As illustrated in FIGS. 4 and 5, the TFT 32 preferably further includes a lower gate insulating film 3212 disposed under the semiconductor film 33 and a lower gate electrode 32G2 disposed under the lower gate insulating film 3212. The lower gate electrode 32G2 overlaps the channel region 331 and the upper gate electrode 32G1. The lower gate electrode 32G2 is formed of a light-transmitting single-layer conductive film or multi-layer conductive film including at least one of W, Cu, Cu alloy, Mo, Mo alloy, Ti, Al, and Al alloy. The lower gate electrode 32G2 is located on the rear side of the channel region 331 to block light applied from the rear side to the channel region 331. For example, the light may be emitted from a backlight device to the liquid crystal panel 10. The light traveling toward the channel region 331 is blocked by the lower gate electrode 32G2, reducing the possibility that the properties of the TFT 32 will be changed by the light applied to the channel region 331.

As illustrated in FIG. 5, a second insulating film is disposed on the interlayer insulating film IDL and a flattening film 39 is disposed on the second insulating film 38 between the interlayer insulating film IDL and the common electrode 35. The second insulating film 38 and the flattening film 39 each extend over substantially the entire area of the glass substrate 30A with a uniform thickness. The second insulating film 38 is a single-layer film or a multi-layer film formed of at least one of inorganic insulating materials, such as SiOx, SiNx, and SiON. The flattening film 39 is formed of a transparent organic insulating material, such as an acrylic resin (for example, PMMA) and a polyimide resin. The flattening film 39 has a larger thickness than the other insulating films (the upper gate insulating film 3211, the lower gate insulating film 3212, and the interlayer insulating film IDL). The flattening film 39 flattens the surface of the array substrate 30.

As illustrated in FIGS. 4 and 5, the second insulating film 38 and the flattening film 39 have a third contact hole CH3 extending through the second insulating film 38 and the flattening film 39 in the thickness direction (Z axis direction) at a position where the drain electrode 32D overlaps the pixel electrode 34 (position corresponding to the second contact hole CH2). The drain electrode 32D is connected to the pixel electrode 34 through the third contact hole. The third contact hole CH3 and the second contact hole CH2 may be a single continuous contact hole.

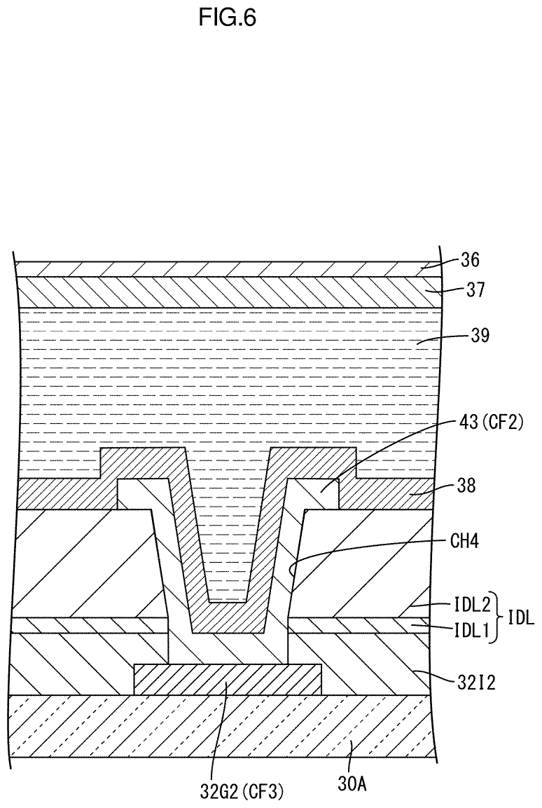

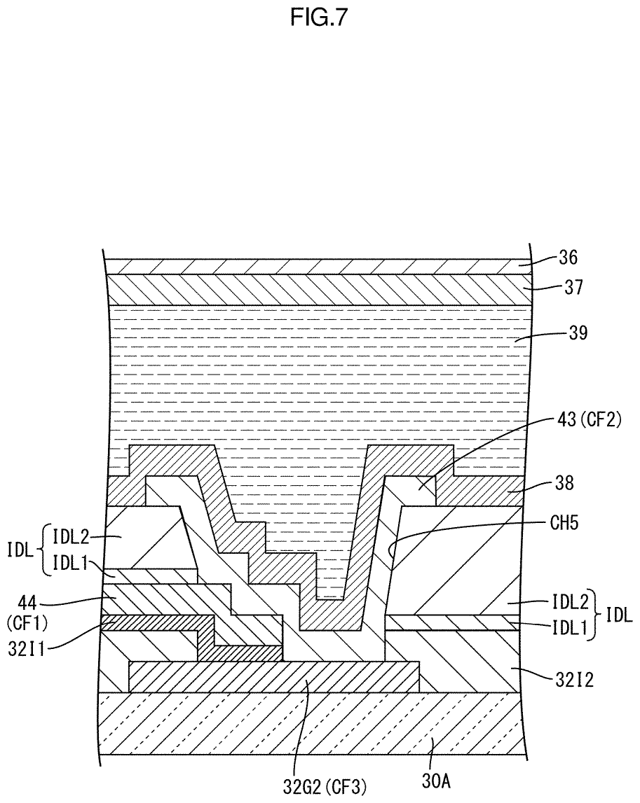

As illustrated in cross-sectional views in FIGS. 6 and 7, the non-display area NAA (FIG. 3) of the array substrate 30 has connections, for example, to the source line 43 and the gate line 44. FIG. 6 illustrates a connection between the source line 43 and the lower gate electrode 32G2. At the connection, a fourth contact hole CH4 (one example of a non-display area contact hole) in the interlayer insulating film IDL extends through the lower gate insulating film 3212 located under the interlayer insulating film IDL. Thus, the lower gate electrode 32G2 and the source line 43 on the inner surface of the fourth contact hole CH4 are connected to each other. FIG. 7 illustrates connections between the source line 43, the lower gate electrode 32G2, and the gate line 44. The interlayer insulating film IDL has a fifth contact hole CH5 (another example of the non-display area contact hole) and the fifth contact hole CH5 extends through the lower gate insulating film 3212 located under the interlayer insulating film IDL. Furthermore, the upper gate insulating film 3211 and the gate line 44 are located between the interlayer insulating film IDL and the lower gate insulating film 3212 over a portion of the inner surface of the fifth contact hole CH5. In this configuration, the source line 43 is located over the gate line 44 and the source line 43 and the gate line 44 are connected to each other. Furthermore, the gate line 44 is connected to the lower gate electrode 32G2 through the source line 43.

As described later, the upper gate electrode 32G1 and the gate line 44 are included in the first conductive film CF1, the source line 43 (and the source electrode 32S connected to the source line 43) is included in the second conductive film CF2, and the lower gate electrode 32G2 is included in the third conductive film CF3. In other words, the second conductive film CF2 and the third conductive film CF3 are connected to each other in the non-display area NAA through the fourth contact hole CH4 in FIG. 6. Furthermore, the first conductive film CF1 and the second conductive film CF2 are connected to each other in the non-display area NAA through the fifth contact hole CH5 illustrated in FIG. 7. In other words, the first conductive film CF1 is also connected to the third conductive film CF3 through the second conductive film CF2.

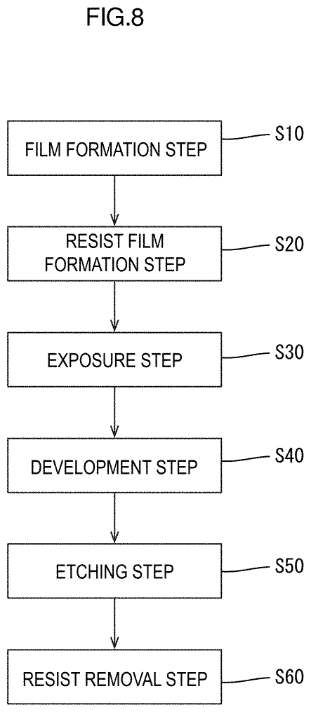

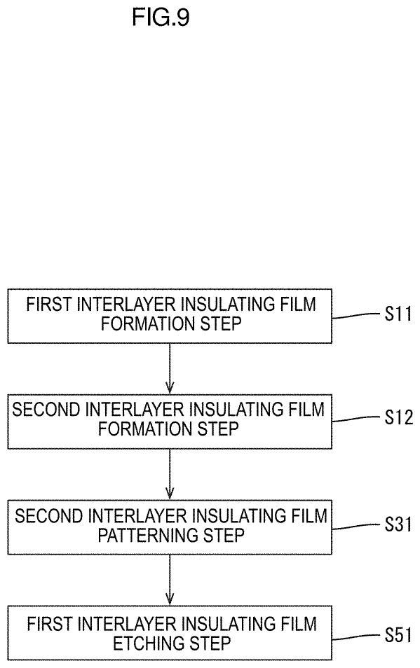

The configuration of the liquid crystal panel 10 according to the first embodiment is as described above. Next, a method of producing the above-described array substrate 30 is described. To obtain the array substrate 30, thin film patterns of various thin films are sequentially formed on the glass substrate 30A such that a multi-layer structure illustrated in FIGS. 5 to 7 is obtained. The thin film patterns of the thin films are each produced by the production process indicated in FIG. 8 or 9. The production process is repeated to form the thin film patterns on the glass substrate 30A. Hereinafter, the production processes are described by using the multi-layer structure illustrated in FIG. 5 as an example.

In the production process of the array substrate 30 of the embodiment indicated in FIG. 8, a third conductive film CF3, which forms the lower gate electrodes 32G2, is first formed on the glass substrate 30A over the entire area (film formation step S10). Then, a positive resist film is applied on the third conductive film CF3 over the entire area to form a resist film on the third conductive film (resist film formation step S20).

Next, portions of the resist film are selectively exposed to light by using a photomask having a pattern to block light at positions corresponding to the lower gate electrodes 32G2 (exposure step S30). Due to the exposure, the pattern of the photomask is transferred to the resist film on the third conductive film CF3. In other words, the resist film is exposed to the light at portions other than the portions corresponding to the lower gate electrodes 32G2.

Next, the glass substrate 30A is put in a developer, such as a tetra methyl ammonium hydroxide (TMAH) solution, to develop the resist film (development step S40). In this step, the portions of the resist film exposed to light in the exposure step S30 are removed and the portions not exposed to the light are left, and thus a resist pattern is formed.

Next, the third conductive film CF3 is etched using the resist pattern on the third conductive film CF3 as a mask such that portions of the third conductive film CF3 are removed (etching step S50). The third conductive film CF3 may be etched by any method. When wet etching using a liquid etchant is performed on a third conductive film CF3 that is a single layer formed of Cu, a mixture of hydrogen peroxide and nitric acid may be used. When dry etching using a gas etchant is performed, a mixture of carbon tetrafluoride (CF4) and oxygen (02) may be used. The etching removes the portions of the third conductive film CF3 not covered with the resist pattern, and thus the thin film pattern having the same pattern as the resist pattern is formed. Then, the resist pattern is removed from the thin film pattern (resist removal step S60). Specifically described, the resist pattern is removed by using a remover solution such as an organic solvent, allowing the thin film pattern to be exposed on the glass substrate 30A. The above-described steps form the thin film pattern of the lower gate electrodes 32G2 on the glass substrate 30A.

Next, an inorganic material forming the lower gate insulating film 3212 is sequentially subjected to the steps from the film formation step S10 to the resist removal step S60 to form a thin film pattern of the lower gate insulating film 3212 on the thin film pattern of the lower gate electrodes 32G2. Then, the various thin films over the lower gate insulating film 3212, i.e., an oxide semiconductor forming the semiconductor film 33, an organic material forming the upper gate insulating film 3211, and the first conductive film CF1 forming the upper gate electrodes 32G1, are each subjected, in this order from the lower side, to the steps from the film formation step S10 to the resist removal step S60. Not all the steps are required for the thin films having the same pattern, e.g. the upper gate electrodes 32G1 and the upper gate insulating film 3211. One or more of the steps may be suitably eliminated.

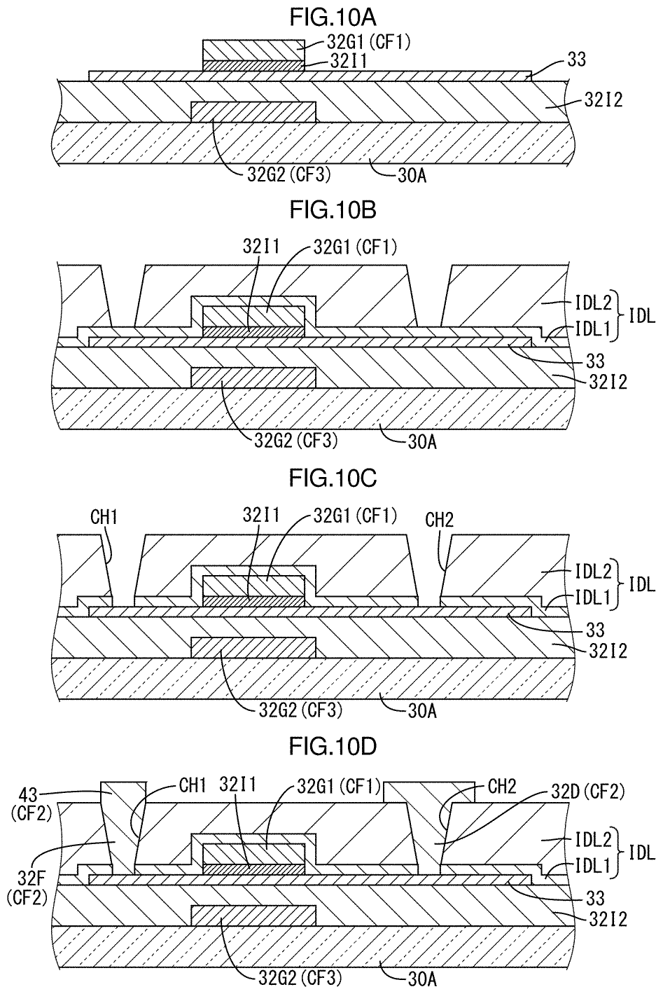

After the formation of the thin film pattern of the upper gate electrodes 32G1 illustrated in FIG. 10A, a thin film pattern of an interlayer insulating film IDL (a first interlayer insulating film IDL1 and a second interlayer insulating film IDL2) is formed in accordance with steps indicated in FIG. 9. Specifically described, the first interlayer insulating film IDL1 formed of an inorganic material is formed first (a first interlayer insulating film formation step S11), and a second interlayer insulating film IDL2 formed of a photosensitive organic material is formed on the first interlayer insulating film IDL1 (a second interlayer insulating film formation step S12). Then, the second interlayer insulating film IDL2 is directly patterned using photolithography such that a thin film pattern of the second interlayer insulating film IDL2 illustrated in FIG. 10B is formed (a second interlayer insulating film patterning step S31). Then, as illustrated in FIG. 10C, the first interlayer insulating film IDL1 under the second interlayer insulating film IDL2 is etched using the thin film pattern of the second interlayer insulating film IDL2 as a mask (a first interlayer insulating film etching step S51). The etching is preferably dry etching using a gas etchant, such as a mixture of carbon tetrafluoride (CF4) and oxygen (02). In dry etching, the etchant is unlikely to flow to the lower surface of the mask (the thin film pattern of the second interlayer insulating film IDL2), and thus the first interlayer insulating film IDL1 is etched more precisely to have the pattern of the second interlayer insulating film IDL2.

Since the first interlayer insulating film IDL1 is etched using the pattern of the second interlayer insulating film IDL2 as a mask, the first interlayer insulating film IDL1 is etched along a hole in the second interlayer insulating film IDL2. Thus, as illustrated in FIG. 10C, the interlayer insulating film IDL has a first contact hole CH1 and a second contact hole CH2, which extend through the interlayer insulating film IDL. Then, a second conductive film CF2 forming the source electrodes 32S, the source lines 43, and the drain electrodes 32D is formed on the interlayer insulating film IDL, and a thin film pattern of the source electrodes 32S, the source lines 43, and the drain electrodes 32D is formed (FIG. 10D) in accordance with the steps indicated in FIG. 8. Then, various thin films located over the source electrodes 32S, the source lines 43, and the drain electrodes 32D, i.e., an inorganic material forming the second insulating film 38, an acrylic resin material forming the flattening film 39, a transparent electrode film ITO forming the common electrode 35, an inorganic material forming the first insulating film 37, and a transparent electrode film ITO forming the pixel electrodes 34, are subjected, in this order from the lower side, to the steps from the film formation step S10 to the resist removal step S60. Not all the steps are required for the thin films having the same pattern, e.g. the second insulating film 38 and the flattening film 39. One or more of the steps may be suitably eliminated.

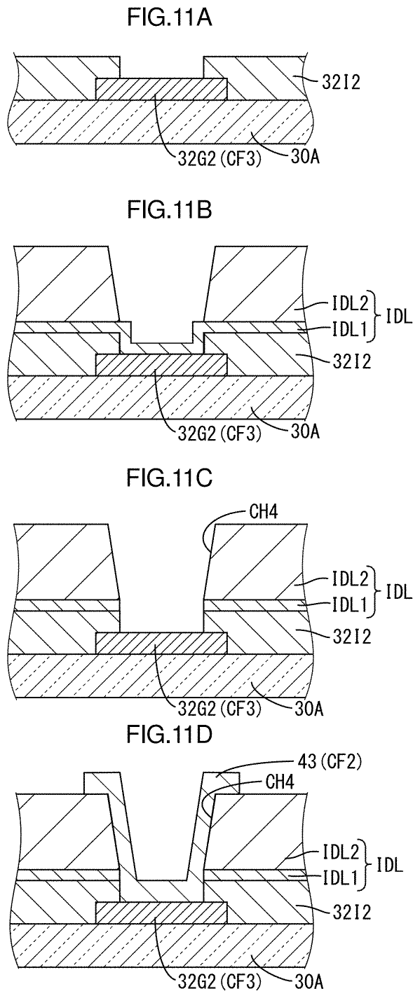

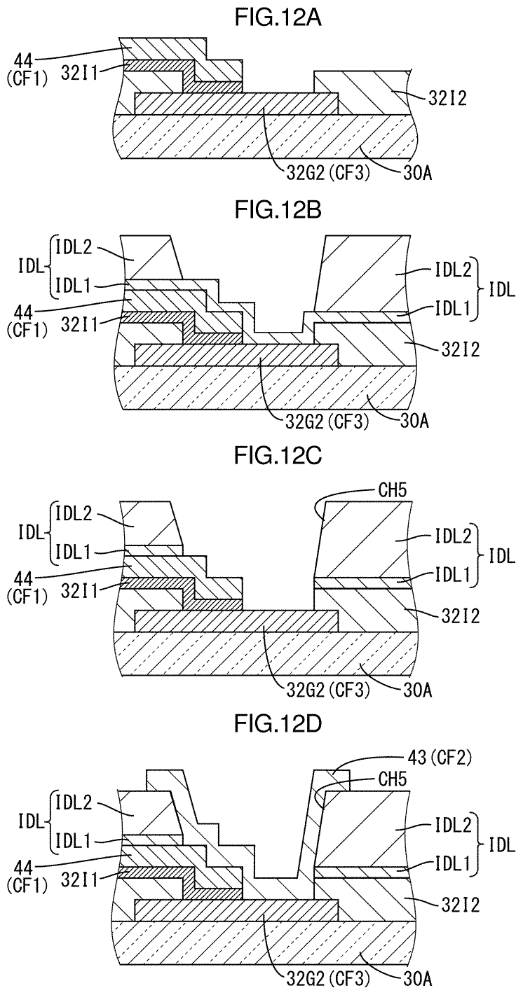

After all the thin film patterns forming the array substrate 30 are formed on the glass substrate 30A, a polyimide resin forming the alignment film 36 is applied onto the array substrate 30. In this way, the multi-layer structure illustrated in FIG. 5 is obtained. The connections between the source lines 43, the gate lines 44, and the lower gate electrodes 32G2 in the non-display area NAA are formed in the same way as described above regarding the display area AA. Thin film patterns of various thin films are sequentially formed on the glass substrate 30A to form a multi-layer structure illustrated in FIGS. 6 and 7. The thin film patterns of various thin films are each formed by the production process indicated in FIG. 8 or 9. The production processes are repeated to form the multi-layer thin film patterns on the glass substrate 30A. FIGS. 11A to 11D illustrate steps of forming a fourth contact hole CH4 extending through the interlayer insulating film IDL of the steps in the production process of the non-display area NAA of the array substrate 30 illustrated in FIG. 6. Furthermore, FIGS. 12A to 12D illustrate steps of forming a fifth contact hole CH5 extending through the interlayer insulating film IDL of the steps in the production process of the non-display area NAA of the array substrate 30 illustrated in FIG. 7.

As described above, the array substrate 30 of the embodiment includes the TFTs 32. The array substrate 30 includes the semiconductor film 33, the upper gate insulating film 3211 disposed over the semiconductor film 33, the first conductive film CF1 disposed over the upper gate insulating film 3211, the interlayer insulating film IDL disposed over the first conductive film CF1, and the second conductive film CF2 disposed over the first conductive film CF1 with the interlayer insulating film IDL therebetween. The gate lines 44 formed of the first conductive film CF1 and the source lines 43 formed of the second conductive film CF2 intersect in a grid pattern to surround the TFTs 32. The TFTs 32 each include the upper gate electrode 32G1 formed of the first conductive film CF1 and continuous with one of the gate lines 44, the source electrode 32S formed of the second conductive film CF2 and continuous with one of the source lines 43, the channel region 331 formed of a portion of the semiconductor film 33 and overlapping the upper gate electrode 32G1, the source region 33S formed of a portion of the semiconductor film 33 and continuous with the channel region 331, and the drain region 33D formed of a portion of the semiconductor film 33 and continuous with the channel region 331 on an opposite side of the channel region 331 from the source region 33S. The source electrode 32S connects the source line 43 and the source region 33S to each other through the first contact hole CH1 extending through the interlayer insulating film IDL, and the interlayer insulating film IDL includes the second interlayer insulating film IDL2 containing a photosensitive material.

In this configuration, the second interlayer insulating film IDL2 is patterned by photolithography, because the second interlayer insulating film IDL2 included in the interlayer insulating film IDL is photosensitive. The second interlayer insulating film IDL2 is able to have a hole extending therethrough in the thickness direction without being etched. Furthermore, the first interlayer insulating film IDL1 is etched using the thin film pattern of the second interlayer insulating film IDL2 as a mask to have the first and second contact holes CH1 and CH2 extending through the interlayer insulating film IDL in the thickness direction. The second interlayer insulating film IDL2 has a larger thickness than the first interlayer insulating film IDL1. For example, in this embodiment, the thickness of the second interlayer insulating film IDL2 is 400 nm and that of the first interlayer insulating film IDL1 is 100 nm. The depth of the hole formed by etching is only 100 nm, which corresponds to the thickness of the first interlayer insulating film IDL1. If the second interlayer insulating film IDL2 is not photosensitive and the interlayer insulating film IDL needs to be etched, the depth of the hole formed by etching is 500 nm. The above-described configuration, in which the second interlayer insulating film IDL2 is patterned by photolithography and only the first interlayer insulating film IDL1 is etched using the patterned second interlayer insulating film IDL2 as a mask, reduces the depth of the hole formed by etching to one-fifth, specifically from 500 nm to 100 nm.

The etching takes less time as the thickness of the film to be etched to form a hole decreases, reducing etching shift of the mask due to the etchant. The reduced etching shift reduces an increase in the opening diameter of the mask, and thus the diameters of the first and second contact holes CH1 and CH2 are not increased. In other words, the first and second contact holes CH1 and CH2 each having a small diameter are formed in this embodiment. The contact holes CH1 and CH2 having smaller diameters allow the light-blocking portion to be smaller, because the contact holes CH1 and CH2 are formed in the light-blocking portion of the display area AA of the liquid crystal panel 10. This increases the aperture ratio of the display area of the liquid crystal panel 10 and that of the liquid crystal display device 100 including the liquid crystal panel 10.

For the same reason, the non-display area NAA of the liquid crystal panel 10 is also able to have the fourth and fifth contact holes CH4 and CH5 each having a smaller diameter. The non-display area contact holes CH4 and CH5 are formed in the frame-shaped non-display area NAA of the liquid crystal panel 10. The contact holes CH4 and CH5 having smaller diameters allow the area of the non-display area NAA (width of the frame) to be smaller. This reduces the frame width of the liquid crystal panel 10 or that of the liquid crystal display device 100 including the liquid crystal panel 10.

<First Modification>

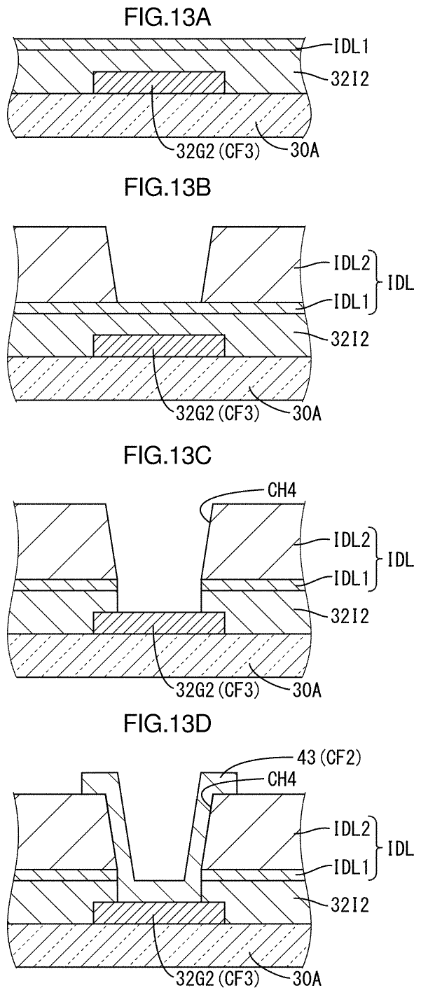

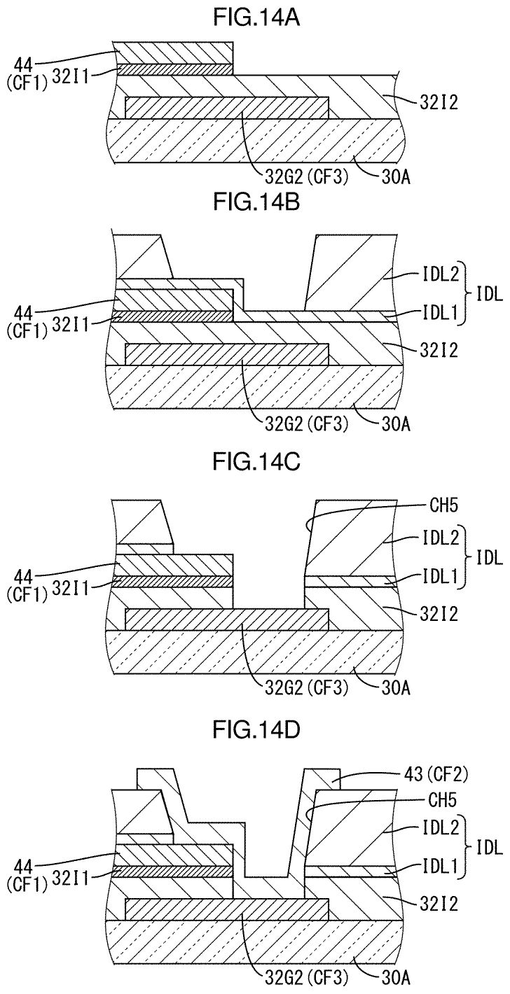

A method of producing an array substrate according to a first modification is described with reference to FIGS. 13A to 14D. In the first modification, the same components, effects, and advantages as those in the first embodiment are not described.

FIG. 13A to 13D sequentially illustrate steps of forming a fourth contact hole in the non-display area of the array substrate according to the first modification. In the first modification, as illustrated in FIG. 13A, a first interlayer insulating film IDL1 formed of an inorganic material (first interlayer insulating film formation step S11) and a second interlayer insulating film IDL2 formed of a photosensitive organic material (second interlayer insulating film formation step S12) are formed on an inorganic material forming a lower gate insulating film 3212. Then, the second interlayer insulating film IDL2 is directly patterned by photolithography to form a thin film pattern of the second interlayer insulating film IDL2 illustrated in FIG. 13B (second interlayer insulating film patterning step S31). Then, as illustrated in FIG. 13C, the fourth contact hole CH4 is formed by etching the first interlayer insulating film IDL1 and the lower gate insulating film 3212, which are located under the second interlayer insulating film IDL2, using the thin film pattern of the second interlayer insulating film IDL2 as a mask.

Furthermore, FIGS. 14A to 14D sequentially illustrate steps of forming a fifth contact hole in the non-display area of the array substrate according to the first modification. In the first modification, as illustrated in FIG. 14A, an inorganic material forming an upper gate insulating film 3211 and a first conductive film CF1 forming the gate lines 44 are formed on the inorganic material forming the lower gate insulating film 3212 (film formation step S10), and the steps from the resist film formation step S20 to the resist removal step S60 are performed to form the thin film patterns of the upper gate insulating film 3211 and the gate lines 44. Then, the first interlayer insulating film IDL1 formed of an inorganic material (first interlayer insulating film formation step S11) and the second interlayer insulating film IDL2 formed of a photosensitive organic material (second interlayer insulating film formation step S12) are formed over the above-described layers. Then, the second interlayer insulating film IDL2 is directly patterned by photolithography to have a thin film pattern of the second interlayer insulating film IDL2 as illustrated in FIG. 14B (second interlayer insulating film patterning step S31). Then, as illustrated in FIG. 14C, the fifth contact hole CH5 is formed by etching the first interlayer insulating film IDL1 and the lower gate insulating film 3212, which are located below the second interlayer insulating film IDL2, using the thin film pattern of the second interlayer insulating film IDL2 as a mask.

In the first modification, the steps relating to the etching of the lower gate insulating film 3212 (the resist film formation step S20 to the resist removal step S60) are eliminated. The first modification differs from the first embodiment in that the etching on the lower gate insulating film 3212 and the etching on the first interlayer insulating film IDL1 are consecutively performed using the thin film pattern of the second interlayer insulating film IDL2 as a mask. This eliminates the steps relating to the etching on the lower gate insulating film 3212 (steps from the resist film formation step S20 to the resist removal step S60), simplifying the production process and reducing the production cost.

<Second Modification>

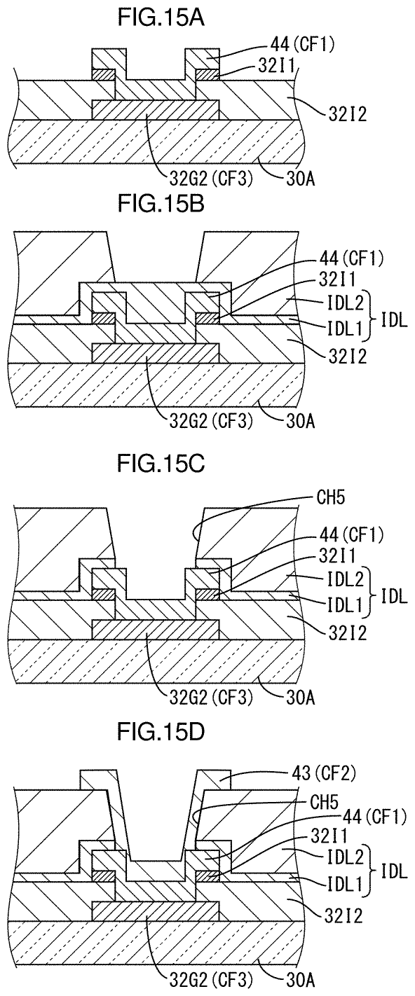

A method of producing an array substrate according to a second modification is described with reference to FIGS. 15A to 15D. In the second modification, the same components, effects, and advantages as those in the first embodiment and the first modification are not described.

FIGS. 15A to 15D illustrate steps of forming a fifth contact hole in the non-display area of the array substrate according to the second modification. In the second modification, as illustrated in FIG. 15A, an inorganic material forming the upper gate insulating film 3211 is applied onto an inorganic material forming a lower gate insulating film 3212 (film formation step S10), and the steps from the resist film formation step S20 to the resist removal step S60 are performed such that the lower gate insulating film 3212 and the upper gate insulating film 3211 are partly patterned. Then, a first conductive film CF1 forming a gate lines 44 is formed on the patterned lower and upper gate insulating films 3212 and 3211 (film formation step S10), and the steps from the resist film formation step S20 to the resist removal step S60 are performed such that thin film patterns of the gate lines 44 and the upper gate insulating film 3211 are obtained. Then, a first interlayer insulating film IDL1 (first interlayer insulating film formation step S11) formed of an inorganic material and the second interlayer insulating film IDL2 (second interlayer insulating film formation step S12) formed of a photosensitive organic material are formed over the thin film patterns. Then, the second interlayer insulating film IDL2 is directly patterned by photolithography to form the thin film pattern of the second interlayer insulating film IDL2 (second interlayer insulating film patterning step S31) as illustrated in FIG. 15B. Then, as illustrated in FIG. 15C, a fifth contact hole CH5 is formed by etching the first interlayer insulating film IDL1, which is located under the second interlayer insulating film IDL2, using the thin film pattern of the second interlayer insulating film IDL2.

In other words, the second modification differs from the first embodiment in that, after the inorganic material forming the lower gate insulating film 3212 is applied, the inorganic material forming the upper gate insulating film 3211 is applied on the inorganic material forming the lower gate insulating film 3212, and the inorganic material forming the lower gate insulating film 3212 and the inorganic material forming the upper gate insulating film 3211 are etched together in the steps from the resist film formation step S20 to the resist removal step S60. Furthermore, the multi-layer structure of the second modification illustrated in FIG. 15D differs from that of the first embodiment illustrated in FIG. 11D. In the multi-layer structure of the first embodiment, the gate line 44 is connected to the lower gate electrode 32G2 with the source line 43 therebetween as illustrated in FIGS. 7 to 11D. In contrast, in the multi-layer structure of the second modification, the gate line 44 is connected to the lower gate electrode 32G2 without the source line 43 therebetween as illustrated in FIG. 15D. In the second modification having such a multi-layer structure, the fifth contact hole CH5 has a further smaller diameter.

In the first and second modifications, the formation portions of the fourth contact hole CH4 (FIGS. 13A to 13D) and the fifth contact hole CH5 (FIGS. 14A to 14D and FIGS. 15A to 15D) in the non-display area NAA of the array substrate 30 are described. However, TFTs constituting the gate driving circuits 45, for example, are also disposed in the non-display area NAA. Thus, although not described above, the first and second modifications further include a step of forming a thin film pattern of a semiconductor film 33 forming the TFTs between the lower gate insulating film 3212 and the upper gate insulating film 3211.

### OTHER EMBODIMENTS

The technology described herein is not limited to the embodiments described above and illustrated by the drawings. For example, the following embodiments will be included in the technical scope of the technology described herein.

(1) In the above-described embodiment, the interlayer insulating film has a two-layer structure including the non-photosensitive first interlayer insulating film and the photosensitive second interlayer insulating film. However, the interlayer insulating film may have a single-layer structure only if the interlayer insulating film contains a photosensitive material. Alternatively, the interlayer insulating film may have a multi-layer structure including three or more layers. In such a case, the total thickness of the photosensitive films is preferably larger than the total thickness of the non-photosensitive films.

(2) The gate lines, the gate electrodes, the source lines, the source electrodes, the drain electrodes, and the thin film patterns of the insulating films in the above-described embodiment are examples and may be suitably modified. Furthermore, the semiconductor film forming the TFTs is formed of an oxide semiconductor material in the above-described embodiment. However, the semiconductor film may be formed of a different semiconductor material.

(3) The production steps in the above-described embodiment may further include, after the development step, a cleaning step of cleaning the glass substrate with a cleaning liquid such as ultrapure water. This enables the portion of the resist film exposed to light in the exposure step to be reliably removed. Furthermore, after the cleaning step, post-exposure bake may be performed to bake the glass substrate. This removes the cleaning liquid adhered to the metal laminated film and the resist pattern in the cleaning step and improves adhesion between the resist pattern and the metal laminated film.

(4) In the above-described embodiment, the liquid crystal panel that operates in an FFS mode is described as an example. However, the technology described herein is applicable to liquid crystal panels that operate in other operation modes, such as an in-plane switching (IPS) mode and a vertical alignment (VA) mode.

(5) In the above-described embodiment, the liquid crystal panel has a rectangular shape in a plan view. However, the technology described herein is applicable to liquid crystal panels having other shapes, such as a square shape, a circular shape, and an oval shape in plan view.

(6) In the above-described embodiment, the liquid crystal panel is described as one example of a display panel. However, the technology described herein is applicable to another type of display panel, such as an organic EL panel, an electrophoretic display panel (EPD), and a micro electromechanical system (MEMS) display panel.

1. A substrate for a display device including thin film transistors, the substrate comprising:
a semiconductor film;
an upper gate insulating film disposed over the semiconductor film;
a first conductive film disposed over the upper gate insulating film;
an interlayer insulating film disposed over the first conductive film; and
a second conductive film disposed over the first conductive film with the interlayer insulating film therebetween, wherein
gate lines formed of the first conductive film and source lines formed of the second conductive film intersect in a grid pattern to surround the thin film transistors,
the thin film transistors each include an upper gate electrode formed of the first conductive film and continuous with one of the gate lines, a source electrode formed of the second conductive film and continuous with one of the source lines, a channel region formed of a portion of the semiconductor film and overlapping the upper gate electrode, a source region formed of a portion of the semiconductor film and continuous with the channel region, and a drain region formed of a portion of the semiconductor film and continuous with the channel region on an opposite side of the channel region from the source region,
the source electrode connects the source line and the source region to each other through a first contact hole extending through the interlayer insulating film, and
the interlayer insulating film contains a photosensitive material.

2. The substrate for a display device according to claim 1, further comprising a pixel electrode connected to the drain region, wherein the pixel electrode is connected to the drain region through a second contact hole extending through the interlayer insulating film.

3. The substrate for a display device according to claim 1, further comprising:
a lower gate insulating film disposed under the semiconductor film;
a third conductive film disposed under the lower gate insulating film and having light-blocking properties; and
a lower gate electrode formed of the third conductive film, wherein
the lower gate electrode overlaps the channel region.

4. The substrate for a display device according to claim 3, wherein the substrate has a display area capable of displaying an image and a non-display area extending along an outer periphery of the display area and uncapable of displaying an image, and
the second conductive film in the non-display area is connected to the third conductive film through a non-display area contact hole extending through the interlayer insulating film.

5. The substrate for a display device according to claim 4, wherein the first conducive film is connected to the second conductive film and the third conductive film through the non-display area contact hole.

6. The substrate for a display device according to claim 1, wherein the interlayer insulating film includes a first interlayer insulating film not having photosensitivity and a second interlayer insulating film disposed over the first interlayer insulating film and having photosensitivity, and
the second interlayer insulating film has a larger thickness than the first interlayer insulating film.

7. The substrate for a display device according to claim 6, wherein the first interlayer insulating film has the same shape in plan view as the second interlayer insulating film.

8. A display device comprising:
the substrate for a display device according to claim 1; and
a counter substrate facing the substrate for a display device with a space therebetween.

9. The display device according to claim 8, further comprising a sealing member disposed between the substrate for a display device and the counter substrate and surrounding the space therebetween to seal the space, and
liquid crystals are sealed in the space.

10. A method of producing a substrate for a display device, the substrate including a semiconductor film, an upper gate insulating film disposed over the semiconductor film, a first conductive film disposed over the upper gate insulating film, a first interlayer insulating film disposed over the first conductive film and not having photosensitivity, and a second interlayer insulating film disposed over the first interlayer insulating film and having photosensitivity, the method comprising:
forming the first interlayer insulating film over the first conductive film;
forming the second interlayer insulating film over the first interlayer insulating film;
patterning the second interlayer insulating film; and
etching the first interlayer insulating film using the patterned second interlayer insulating film as a mask to selectively remove a portion of the first interlayer insulating film and pattern the first interlayer insulating film.

11. The method of producing a substrate for a display device according to claim 10, wherein the etching on the first interlayer insulating film is dry etching using a gas etchant.
